(19) United States
(12) Patent Application Publication
(10) Pub. No.: US 2024/0169854 A1
(43) Pub. Date: May 23, 2024

(54) IDENTIFICATION AND VERIFICATION OF BEHAVIOR AND EVENTS DURING INTERACTIONS

(71) Applicant: TRULEO, INC., CHICAGO, IL (US)

(72) Inventors: TEJAS SHASTRY, CHICAGO, IL (US); MATTHEW GOLDEY, ZIONSVILLE, IN (US); JOSEPH HEENAN, HEUSENSTAMM (DE); ANTHONY TASSONE, SAINT CHARLES, IL (US); HALLIE ASTON, NEW YORK, NY (US); COREY BURROWS, LISLE, IL (US)

(73) Assignee: TRULEO, INC., CHICAGO, IL (US)

(21) Appl. No.: 18/500,541

(22) Filed: Nov. 2, 2023

Related U.S. Application Data
(60) Provisional application No. 63/382,068, filed on Nov. 2, 2022.
(60) Provisional application No. 63/382,069, filed on Nov. 2, 2022.
(60) Provisional application No. 63/485,362, filed on Feb. 16, 2023.

(51) Int. Cl. G09B 5/06; G10L 17/02; G10L 17/14; G10L 25/57; G10L 25/63

(52) U.S. Cl. CPC G09B 5/065; G10L 17/02; G10L 17/14; G10L 25/57; G10L 25/63

(57) ABSTRACT

Natural language processing can analyze language in apparatus, systems, and methods involving audio, including from body camera video footage, which can be transcribed to extract an audio segment from a video track, to identify starting and ending timestamps of voice, to transcribe the at least one audio segment to identify and separate audio of at least a first speaker, and to score the audio of the first speaker to identify interactions of interest. Audio could be analyzed and scored to record verbal performance, respectfulness, wellness, etc. and speakers from the audio can be detected. Evaluations of officer behavior can be labeled by a machine and confirmed by a human reviewer to identify critical events and justification. Voice printing can be used to identify individual speakers and the audio segments can be weighted to identify key phrases. Positive and negative language in an interaction can be identified using natural language processing.

### CROSS-REFERENCE TO RELATED APPLICATIONS

This application claims the benefit of U.S. Provisional Patent Application No. 63/382,068, filed Nov. 2, 2022, of U.S. Provisional Patent Application No. 63/382,069, filed Nov. 2, 2022, and of U.S. Provisional Patent Application No. 63/485,362, filed Feb. 16, 2023, the entire contents of each of which are incorporated by reference as if repeated herein.

### SUMMARY

Patrol officers wearing body worn cameras (BWC) produce hundreds of hours of video per month. These videos create massive quantities of data, which are of such voluminous size that review by police departments is limited. In at least one aspect, supervisors (for example, sergeants or lieutenants) are interested in reviewing BWC videos for individual officers or in analyzing individual encounters. For example, a supervisor may want to analyze officer behavior, such as officer directed profanity or foul language, or events, such as involving a use of force. However, the sheer quantity of data makes it difficult, if not impossible, for supervisors to review all videos in order to surface videos of interest for analysis. As many police departments look for better oversight and training of their police force, few departments are able to leverage body camera data as a source of insight into their interactions with the community.

Further, even if specific videos of interest are identified, the process of reviewing critical events within these videos can still be burdensome. Even further, many police departments prefer to adopt a “four-eyes” policy on officer behavior, meaning every machine-detected event should be reviewed and verified by a supervisor. In at least one exemplary embodiment, a rapid verification interface is described herein. The rapid verification interface, which can be machine based, can provide an inbox that includes critical event labels that have not been verified. In at least one instance, for example, event labels that have not been verified can be reviewed by a supervisor by automatically playing videos starting at a segment before the segment in question, avoiding the need for a supervisor to find a relevant point in time where review is needed. The supervisor is presented with a segment for evaluation and then responds and/or labels the segment, for example, with “yes”, “no”, “not officer”/“not applicable”, “skip”, etc.

In at least one aspect, the apparatus, systems, methods, and processes described herein offer departments an efficient and effective way of analyzing body camera data. The analysis can be utilized in many aspects, including efforts to improve training tactics, provide better oversight, etc.

In another aspect, apparatus, systems, and/or methods of analysis of audio from BWC, including through natural language processing (NLP) are detailed. The audio can be analyzed in real-time, such as, for example, during a police encounter, or alternatively, at least a portion of the audio can be analyzed at a later time.

In at least one instance, officers need to be identified in police interactions, for example, in order to correctly separate a transcript into individual speakers and to correctly identify which speaker is the officer wearing the camera. The process of assigning audio to speakers is called speaker diarization. Researchers evaluate speaker diarization models on the accuracy in assigning words or audio to different speakers. For clean audio with well-separated speakers, state of the art models are capable of assigning speakers with up to 95% accuracy. If speakers speak over one another or are in a noisy environment, even state of the art models often can only achieve 50% accuracy or worse. BWC videos of police interactions often contain volatile situations, and, thus, these police interactions often involve noisy environments that require evaluation.

In another aspect, one exemplary embodiment can involve the use of a body camera analytics platform that can involve, for example, transcription of audio to text, identification of an officer speaking, identification of events occurring or that occurred in an officer civilian interaction via NLP, identification of positive, professional language in the interaction via NLP (such as explanations or politeness), and/or identification of negative language in the interaction (such as profanity, insults, threats, etc.).

### BRIEF DESCRIPTION OF THE DRAWINGS

The accompanying drawings, which are incorporated herein and constitute part of this specification, illustrate the presently preferred embodiments of the disclosure, and, together with the general description given above and the detailed description given below, serve to explain exemplary features of the disclosure. In the drawings:

FIG. 1 shows an exemplary video according to an exemplary embodiment of an interface for review.

FIG. 2 shows an exemplary menu or set of options available for review of an exemplary video(s) according to the exemplary embodiment of FIG. 1.

FIG. 3 shows a browser interface according to the exemplary embodiment of FIG. 1.

FIG. 4 shows another browser interface according to the exemplary embodiment of FIG. 1.

FIG. 5 shows an exemplary end-to-end flow of body camera or cam audio analysis.

FIG. 6 shows a table with example features extracted via intent and sentiment analysis of a body cam transcription segment.

FIG. 7 shows an example analysis showing intent labels and sentiment polarity of an event extracted from body camera audio.

FIGS. 8A and 8B show an exemplary analysis of transcribed audio and sentiment summaries.

FIGS. 9A and 9B show an aggregate summary of metrics and combinations with top metrics.

FIG. 10 shows exemplary summaries across various officers.

FIG. 11 shows exemplary training of an intent and entity model.

FIG. 12 shows exemplary weights of positive coefficients.

FIG. 13 shows exemplary weights of negative coefficients.

FIG. 14 shows an exemplary transcription of an interaction between an officer and a driver with a flat tire.

FIG. 15A shows an exemplary speaker embedding of a converted word-based audio segment and FIG. 15B shows a grouping of similar speaker embeddings grouped together.

FIG. 16 shows application of a target officer in exemplary BWC videos.

FIG. 17 shows exemplary officer ID accuracy comparing text classifiers only and officer voice printing.

FIG. 18 shows a workflow diagram of BWC videos from multiple officers and application to identify an officer voice fingerprint.

FIGS. 19-21 show exemplary flow charts of methods of an exemplary embodiment of identifications of events and language during interactions.

### DETAILED DESCRIPTION

In the drawings, like numerals indicate like elements throughout. Certain terminology is used herein for convenience only and is not to be taken as limiting. The terminology includes the words specifically mentioned, derivatives thereof, and words of similar import. The embodiments illustrated below are not intended to be exhaustive or to limit to the precise form disclosed. These embodiments are chosen and described to best explain the principles, application, and practical use, and to enable others skilled in the art to best utilize the present disclosure.

In at least one aspect, the present disclosure details analysis of audio, such as from video tracks and/or real-time interactions from audio or video recordings. Several examples provided herein involve body cameras, also termed body worn cameras, and police officers. These scenarios are presented as exemplary only and not intended to limit the disclosure in any manner. This disclosure could be applied without limitation to other sources. For example, such alternative scenarios could not involve police officers, could be from cameras that are not body worn, etc. In other examples, the body cam can be worn by an emergency technician, a firefighter, a security guard, a citizen instead of a police officer, police during interview of a suspect, interactions in a jail or prison, such as, for example, between guards and inmates or between inmates, or other person(s). Additionally, the body cam can be worn by an animal or be positioned on or in an object, such as a vehicle. It is understood, therefore, that this disclosure is not limited to the particular embodiments disclosed, but it is intended to cover modifications within the spirit and scope of the present disclosure as defined by the appended claims. The same behavior and emotional sentiments captured can also be applied to scenarios including, but not limited to, conversations within sales teams, conversations involving financial transactions, conversations between counterparties where one party may be privy to valuable information that they cannot share with the other, or conversations between counterparties where one holds a degree of power (legal, authoritative, managerial, etc.) over another.

### Rapid Verification of Officer Behavior

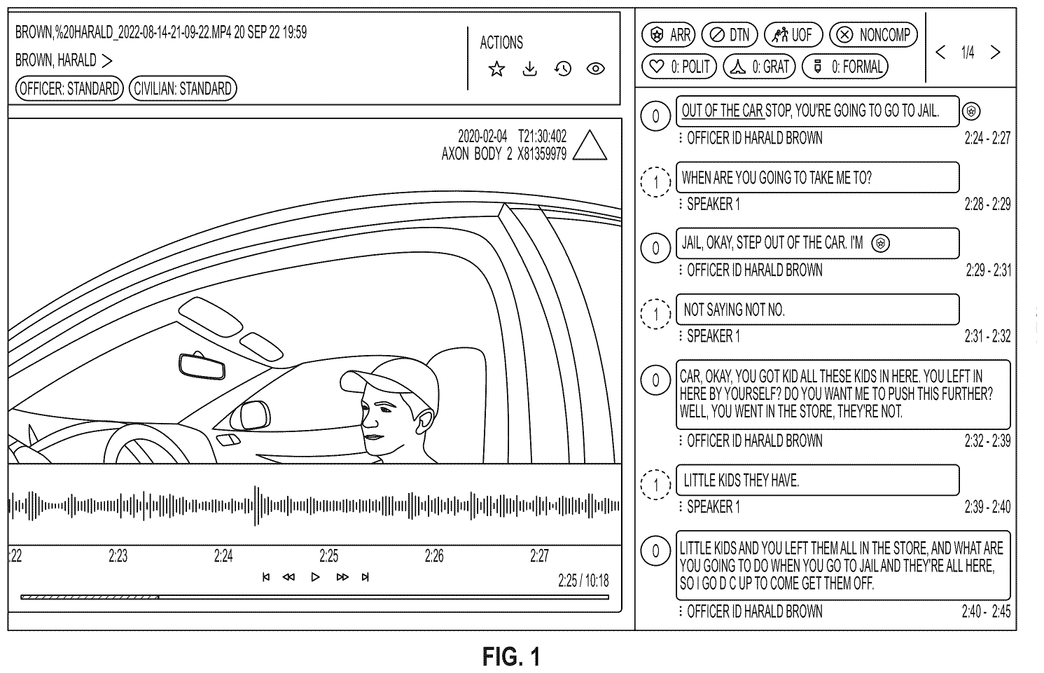

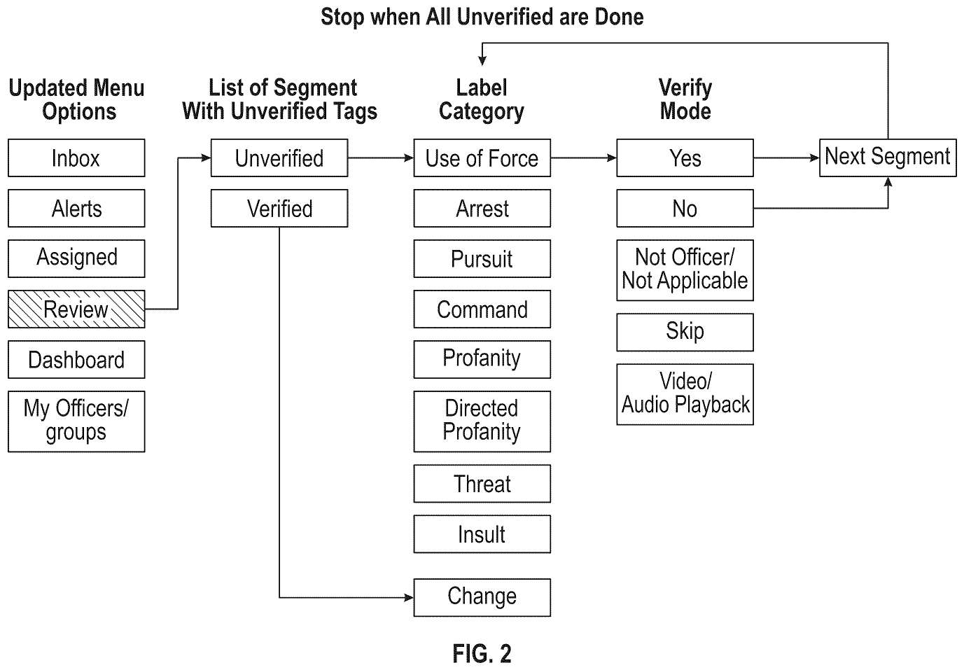

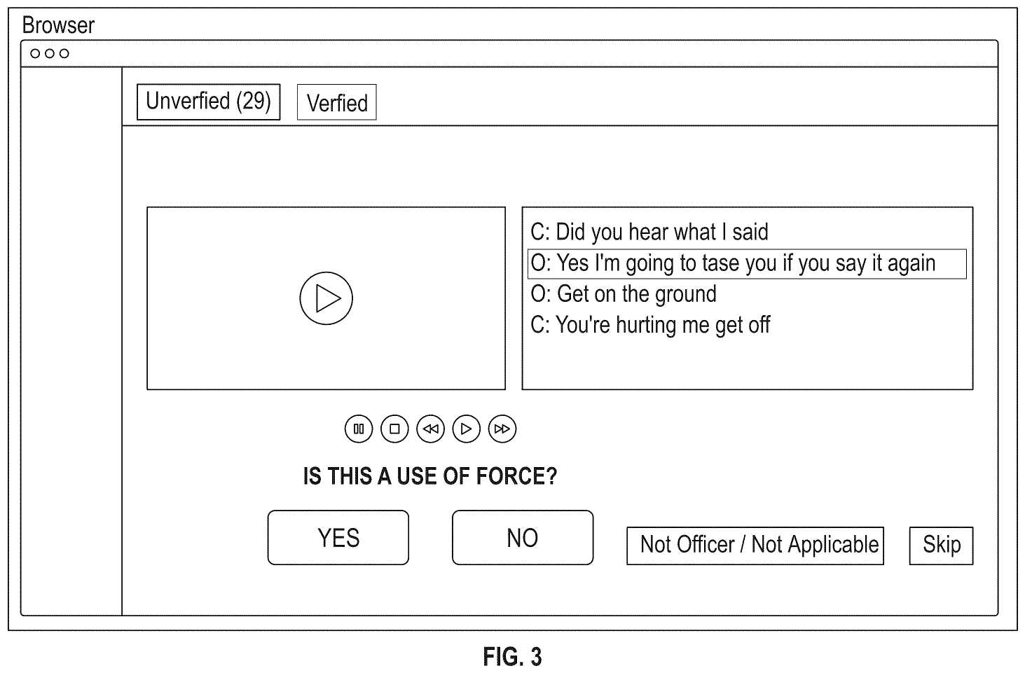

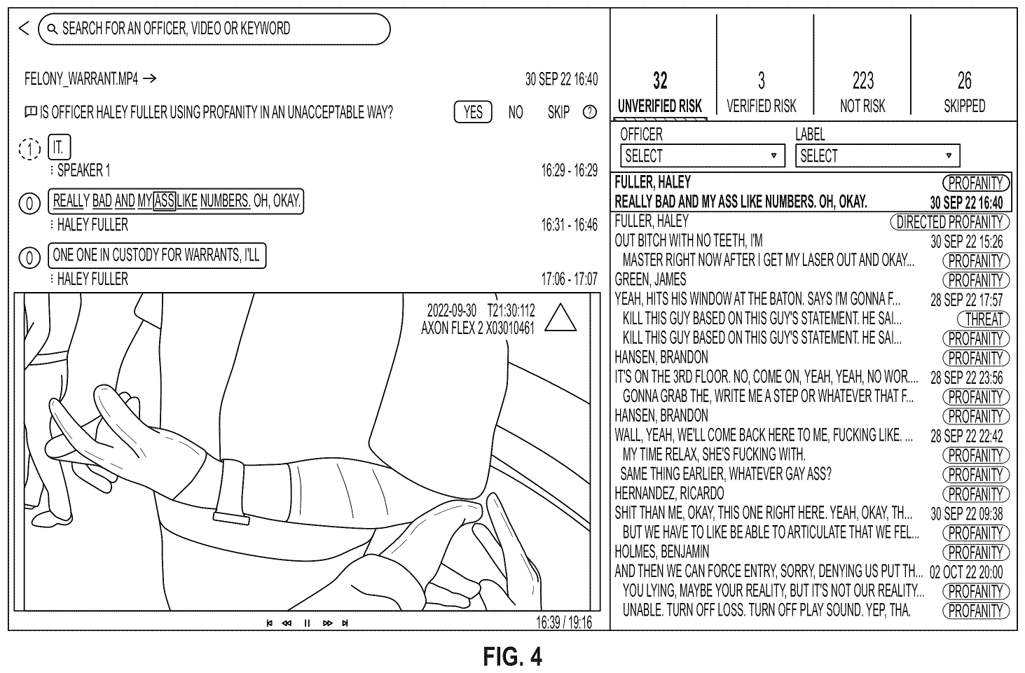

In at least one exemplary embodiment, supervisors are interested in reviewing BWC videos, such as, for example the exemplary video screen shot shown in FIG. 1, to analyze officer behavior, such as officer directed profanity or foul language, or events such as a use of force. In one exemplary rapid verification interface described herein, an inbox of critical events provides labels that have not been verified. The supervisor is presented with a segment the supervisor can evaluate and then respond and/or label, for example, with “yes”, “no”, “not officer”/“not applicable”, “skip”, etc. FIG. 1 shows an exemplary video according to an exemplary embodiment of an interface for review. FIG. 2 shows an exemplary menu or set of options available for review of an exemplary video(s) according to the exemplary embodiment of FIG. 1. FIG. 3 shows a browser interface according to the exemplary embodiment of FIG. 1. FIG. 4 shows another browser interface according to the exemplary embodiment of FIG. 1.

A response of “yes” can be a label that asserts at least two things: (1) that the machine correctly identified a critical event and (2) that the event was unjustified. A response of “no” can be a label that signifies that the machine did not correctly identify an event or that the behavior was justified. A response of “not officer” or “not applicable” can be a label that signifies that the machine did not correctly identify the officer or did not correctly understand the context, and therefore there is no critical event present. A response of “skip” can be a label that typically retains the video in a queue for later review. Because the segments are ordered and grouped by video, the interface automatically advances to the next segment within the video. In at least one exemplary embodiment, the application (app) can force a user to skip segments that have been in the queue too long in an effort to ensure a critical event is quickly addressed.

In at least one instance, a mobile version of the interface can be provided. The mobile version of the interface could allow, for example, directional swiping to review and respond to videos. Thus, as an example, the mobile app could allow a left swipe to equate to “no”, a right swipe to equate to “yes”, an up swipe to equate to “not officer”/“not applicable”, and a down swipe to equate “skip”.

In at least one example detailed herein involving police officers, research shows that language used in police interactions as measured by humans reviewing body worn camera (BWC) video shows disparities in officer behavior based on the use of respectful or disrespectful language (see, e.g., PNAS article entitled “Language from police body camera footage shows racial disparities in officer respect”, Jun. 5, 2017, as listed on the correspondingly filed information disclosure statement). Simply put, using more respectful language leads to fewer escalated scenarios. However, the vast amount of footage to be reviewed to make determinations of the use of respectful language across a department is nearly impossible to process with solely human review.

In at least one aspect, the present disclosure details transcription of BWC audio and separation of the audio into individualized, anonymous speakers. In at least one example, the speaker wearing the camera is tagged anonymously as the officer. The systems and methods described involve NLP models operable to run on the speaker-separated transcript, identifying key phrases associated with unprofessional or professional/respectful interactions. Features are weighted based on a department's preference for detection (e.g., directed profanity is worse than informality, etc.). In addition, the present systems and methods can tag events, like arrests and use of force, as a further dimension to analyze behavior. In at least one embodiment, the officer identification allows selectively transcribing and/or analyzing only the officer(s) only, or only transcribing and/or analyzing the civilian (or other non-officer) audio, or both the officer(s) and civilian(s). While there may be several reasons for allowing selective transcription or analyzing, in at least one instance, this option could be important for legal mandates, including, to not analyze, or specifically redact, civilian or officer audio in relevant cases. In other aspects and exemplary scenarios, redaction of officer, civilian, or other audio may apply to sections or entire segments of transcripts or selections.

In at least one aspect, the detailed systems and methods utilize NLP models that use a modern architecture termed a “transformer”. These models learn based on context, not keywords. Thus, seeing a word used in context, the models can automatically extrapolate synonyms or other potential variations of the word. In this way, the models of the present detailed systems and methods are able to capture key phrases associated with unprofessionalism and professionalism with only a handful of examples.

### Officer Detection

Given a set of anonymous speakers, it is nearly impossible to figure out who the officer is on conventional methods like voice fingerprinting. Instead, in at least one aspect, the present detailed systems and methods use an assumption common to body-worn camera usage: that the person wearing the camera is the officer.

The present detailed systems and methods measure the voice quality of each speaker using a set of metrics that include:
Short Time Intelligibility Measure (stoi)
time domain segmental signal to noise ratio (SNRseg)
frequency weighted segmental signal to noise ratio (fwSNRseg)
Normalized Covariance Metric (ncm)

The highest signal quality is labeled as a potential officer. In some cases, multiple speakers may still have high quality signal, if for example the officer is facing away from the microphone and a civilian is talking directly. In these cases, the present detailed systems and methods use an additional text-based classifier that is trained on officer-specific language patterns.

### Scalable, Compliant Ingestion of Body Camera Audio

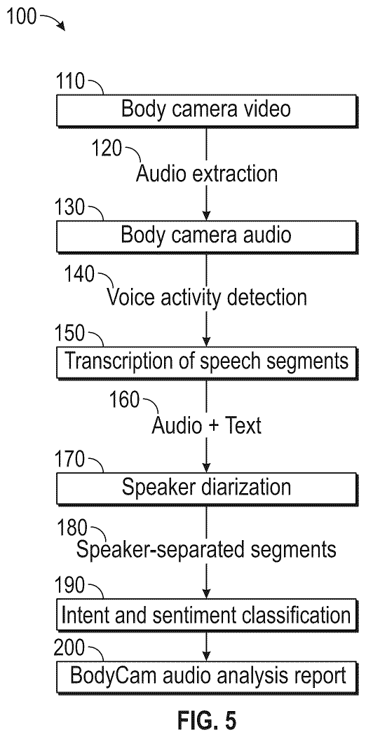

FIG. 5 shows an exemplary method for reducing the footprint of data for efficient analysis. As many police departments produce hundreds to thousands of hours per day of body camera recordings across their police force, it is challenging, if not prohibitive, to process such a large amount of data in a cost effective form.

FIG. 5 shows an exemplary analysis flowchart 100 of body camera video footage 110. The footage is first processed such that the audio track is isolated from the video at 120. Discarding video information initially by retaining only the audio can greatly reduce the cost of and increasing the speed of transferring data and analyzing data with machine learned models. For example, audio may only be a fraction (e.g., for example, 5%) of the information in a selection of footage, which could, in some instances, markedly increase the speed of transfer and analysis while markedly reducing the cost. Next, the audio 130 is streamed through a voice activity detection model at 140, which identifies the starting and ending timestamps within the audio track where voice is detected at 150. These sections of audio 150 are streamed into an automatic speech recognition model that outputs the text transcription of the selection of audio at 160. At 170, speaker diarization is performed to create speaker segmented segments at 180. At 190, intent and sentiment classification is performed and a body cam audio analysis report is issued at 200.

In at least one embodiment, during the entire pipeline process, audio is only retained in temporary memory and not written to disk, enabling a privacy-compliant method for transcribing sensitive audio. The separated audio data can be streamed in real-time for analysis or from an already stored file. Subsequent analysis of the file, including based on the features of interest documented below, can be used as a determination of whether a recording should be maintained long-term, including if it contains data of interest. In at least one embodiment, the original audio from the video file is added in “long term storage”, and can be analyzed at a subsequent time. In one example, the analysis documented could be used as a way to determine videos of interest. Here, for example, a video termed “of interest” could be retained for long term storage, while a video not termed “of interest” could be deleted, classified, or recommended for deletion, including for further analysis before deletion. Additionally, in at least one embodiment, metadata relating to the officer wearing the camera, the date and time, and location data can be maintained along with the corresponding audio during processing.

### Speaker Diarization of Audio

In at least one exemplary embodiment, as the audio stream is transcribed into text, each word is assigned a start and stop time. Segments of the audio transcript are generated by the speech recognition model based on natural pauses in conversation.

In at least one embodiment, the audio and text is then further streamed to a speaker diarization model that analyzes the audio stream for speaker changes, as shown at 170 in FIG. 5. If a speaker change occurs and is measured by the model, the text is periodically re-segmented such that segments contain only a single speaker, e.g. at 180 in FIG. 5. In at least one embodiment, this process is performed after transcription, rather than during or before, such that noises and other disruptions that are common in body cam audio do not adversely affect a continuous single speaker transcription. If diarization is performed before transcription, these breaks can break the continuity of the transcription in a way that can lower transcription accuracy.

### Intent and Entity Classification and Sentiment Analysis of Transcribed Audio

In at least one embodiment, after transcription and diarization, the speaker-separated text transcription is analyzed through an intent classification model. The intent classification model utilizes a deep-learned transformer architecture and, in at least one example, is trained from tagged examples of intent types specific for police interactions. Specifically, in at least one exemplary embodiment, intent labels classify words or phrases as: ‘aggression’, ‘anxiety’, ‘apology’, ‘arrest’, ‘bias’, ‘bragging’, ‘collusion’, ‘de-escalation’, ‘fear’, ‘general’, ‘gratitude’, ‘manipulation’, ‘mistrust’, ‘reassurance’, ‘secrecy’, etc. The classifier can also tag “events” by words and phrases, in at least one example, effectively tagging as the consequence of a speaker's intent. In at least one exemplary scenario, such a classifier can identify “get your hands off of me” as a “use of force” event, or “you have the right to remain silent” as an “arrest” event.

In one aspect, the intent classification leverages types of features to determine the correct intent with one or more models or model layers. First, the entire text of the segment is chunked into words up to a maximum defined sequence length. Second, each segment of text is run through one or more transformer-based models. Each transformer model either outputs a single intent label (as mentioned above) or a set of entity labels (such as person, address, etc.). For models where a single intent label is captured, that single intent label is used as is. For models where entity labels are captured, those captured labels are subject to further analysis by a layer of the model that determines the final intent label. Many transformer architectures lend themselves to stacking similar model layers. Thus, the intent and entity models can be combined for some or all of the labels listed above, such that a single model performs both tasks and outputs a single intent label.

In at least one embodiment, alongside the intent classifier, a sentiment analysis model tags each segment in three ways:

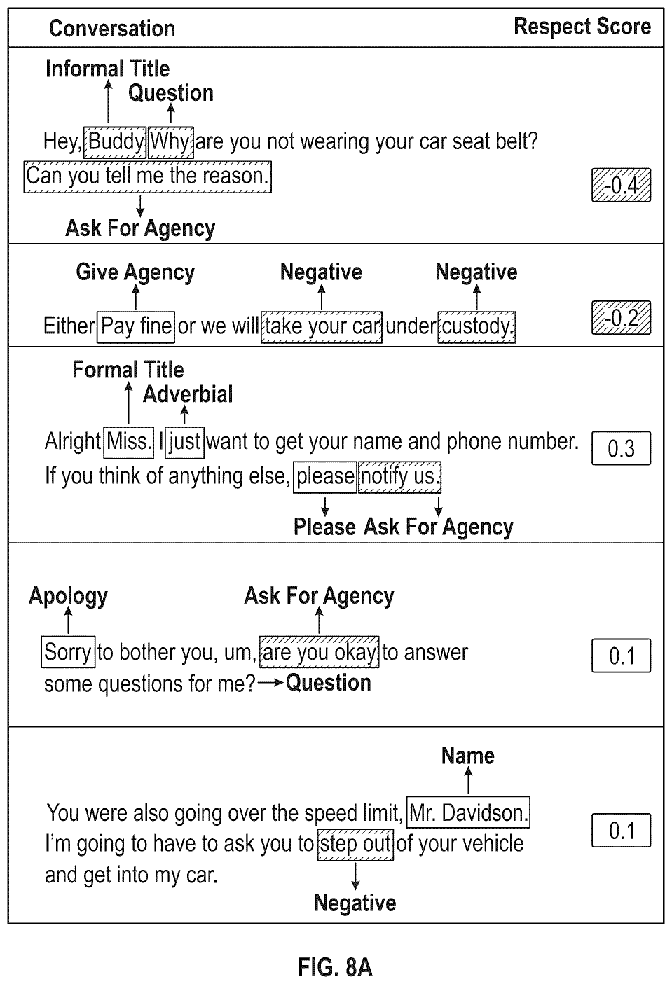

First, in at least one exemplary embodiment, the labels of ‘very positive’, ‘positive’, ‘neutral’, ‘negative’, and ‘very negative’ are output by the sentiment classifier trained in a similar way to the intent classifier, each with a probability. The aggregate probability of “positive” labels is subtracted from the aggregate probability of “negative” labels to produce a sentiment polarity. The probability of the top label subtracted from 1 is used as a “subjectivity” score. The subjectivity score gives an estimate of how likely it is that two human observers would differ in opinion on the interpretation of the polarity. Thus, sentiment labels can be filtered for ones with “low subjectivity”, which may provide more “objective” negative or “objective” positive sentiments and be used to objectively quantify the sentiment of an event. Where highly objective negative statements can identify interactions of interest where either an officer or a person of interest is escalating a situation, likewise, highly objective positive statements can identify successful de-escalation of a situation (see, for example, the conversation in FIGS. 8A and 8B).

Second, in at least one exemplary embodiment, the transcribed text output is analyzed for word disfluencies. Disfluencies are instances of filler words (uh, uhms, so, etc.) and stutters. These disfluencies can be an indicator of speaker confidence, and the log-normalized ratio of disfluencies in each segment compared to the number of words is output as a second sentiment metric.

Third, entities detected by the intent classifier previously mentioned can be given manual weights that correlate with positive or negative sentiment, such as an entity capturing “profanity” weighted as “very negative” with a score of −1.0.

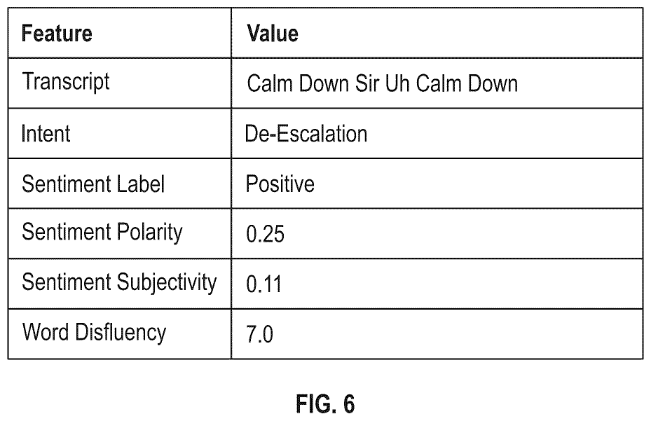

An example output of these metrics for a particular phrase is shown at 300 in Table 1 in FIG. 6. The phrase “calm down sir uh calm down” is transcribed and labeled for intent (de-escalation), sentiment label (positive), sentiment polarity (0.25), sentiment subjectivity (0.11), and word disfluency (7.0).

### Identification of De-Escalation Events and Analysis of Bias

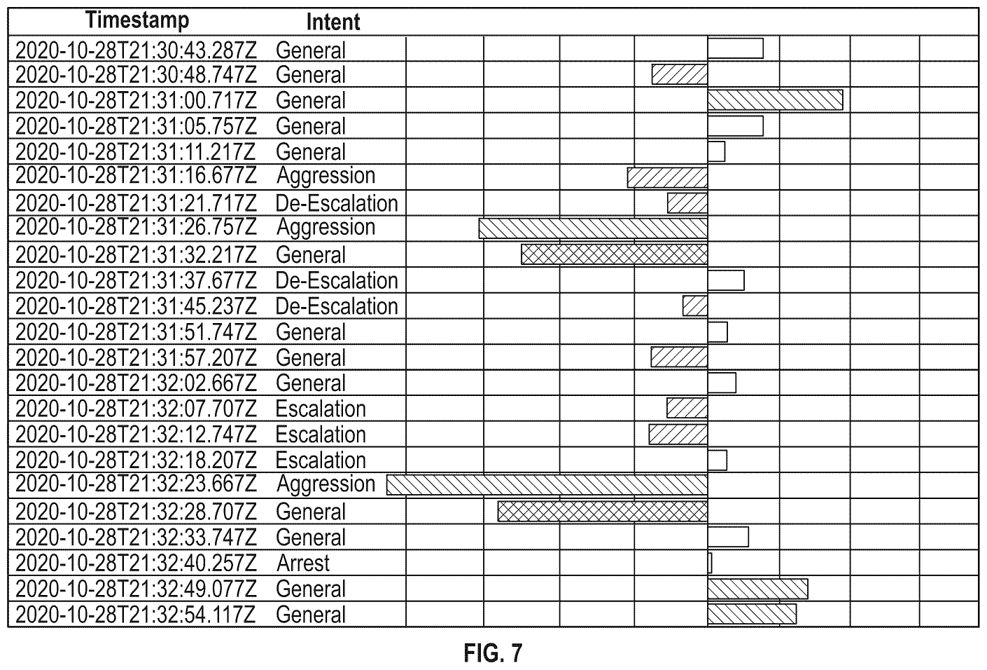

In at least one exemplary embodiment, the combination of sentiment and intent labels across speaker-separated segments of the body cam audio transcript enables the identification of de-escalation events and their efficacy. FIG. 7 shows an example of an event analyzed by one exemplary method described in at least one aspect herein. FIG. 7 shows an exemplary method that involves a communication between police and community participants, where both instances of positive and negative sentiment can be seen (for example, note extensions from centralized vertical line). Following negative sentiment, in this exemplary embodiment shown in FIG. 7, de-escalation phrases are used to attempt to resolve sentiment to a neutral or positive position. In the exemplary event shown in FIG. 7, several de-escalation events are necessary before sentiment stabilizes, but the event eventually escalates to an arrest (for example, note third from bottom entry).

In FIG. 7, the time from the initial negative sentiment event to the arrest can be determined as the “de-escalation time”, and, for example, the transcript of the segments of de-escalation can be further analyzed and compared to other events to determine which phrases lead to the fastest and most successful de-escalations.

For events such as the one shown as represented in FIG. 7, a police report is typically generated documenting features such as the gender and race of the suspects or participants involved. The report and analysis can provide joint value in at least two ways. Features within the transcript that are identified, such as persons, addresses, weapons, etc., for example, can be used to populate the report automatically. Second, the report data can be compared against event analyses such as the one shown in FIG. 7, to identify whether sentiment polarity or word disfluency differs between interactions of participants of different races, which, among other things, can be indications of racial bias.

Further, since the features extracted effectively classify body cam videos as ones with “content of interest” (including, e.g., strongly negative or positive sentiment, a large number of sentences with strong emotions, such as aggression, misconduct, etc.), the analysis performed by the engine can be used as a method to identify videos that should be retained long term and/or enable departments to delete videos that are not of interest, e.g., due to lack of interesting content. This deletion could save storage costs for police departments.

Exemplary usage of the analysis is shown in FIGS. 8A-10 in the form of summarized reports generated from the analysis on audio from FIG. 7. FIG. 8A shows an analysis of the transcribed audio where particular phrases and entities are tagged as positive sentiment, negative sentiment, or various behaviors and emotions. The average sentiment polarity as described above can be interpreted as a “respect score”, and a summary of the number of times respectful versus disrespectful interactions can be generated as shown in FIG. 8B. These aggregate metrics enable tracking, for example: (1) the overall respectfulness of officers over time by comparing the number of respectful versus disrespectful interactions, e.g., month over month, and (2) the ways in which officers are being respectful or disrespectful in an effort to expose areas of improvement for police training, etc.

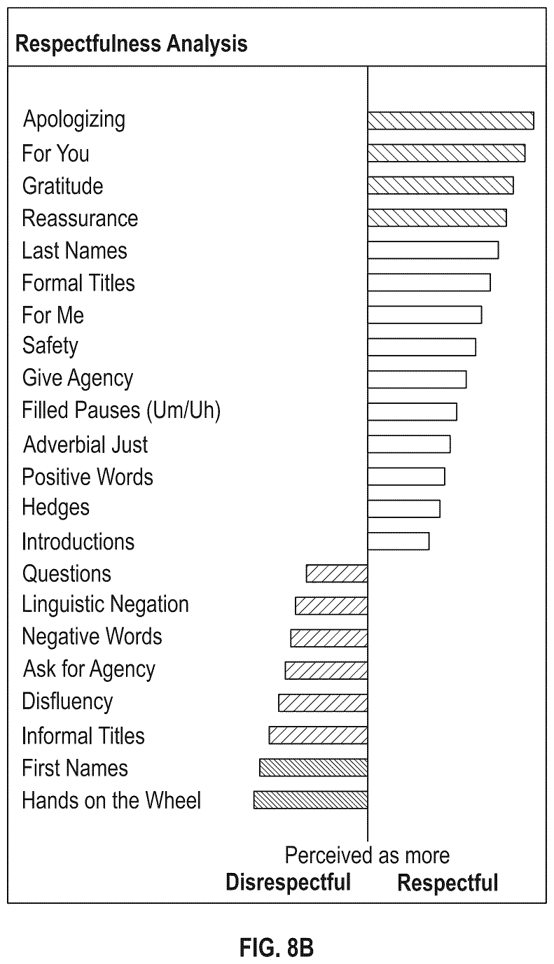

FIGS. 9A and 9B show interpretations of the FIG. 7 analysis from FIGS. 8A and 8B. As previously mentioned, points of negative sentiment can be identified as beginning of event escalations, and contrastingly, points of positive sentiment can be identified as end of escalations. The classified behaviors and emotions between those points can be identified as de-escalation tactics, and the efficacy of these tactics can be measured by comparing the time required for sentiment to resolve from negative to positive. FIG. 9A shows an aggregate summary of these metrics and, combined with a list of top metrics in FIG. 9B, a department can utilize these metrics to identify police tactics, behaviors, and phrases that are most successful at de-escalation of events.

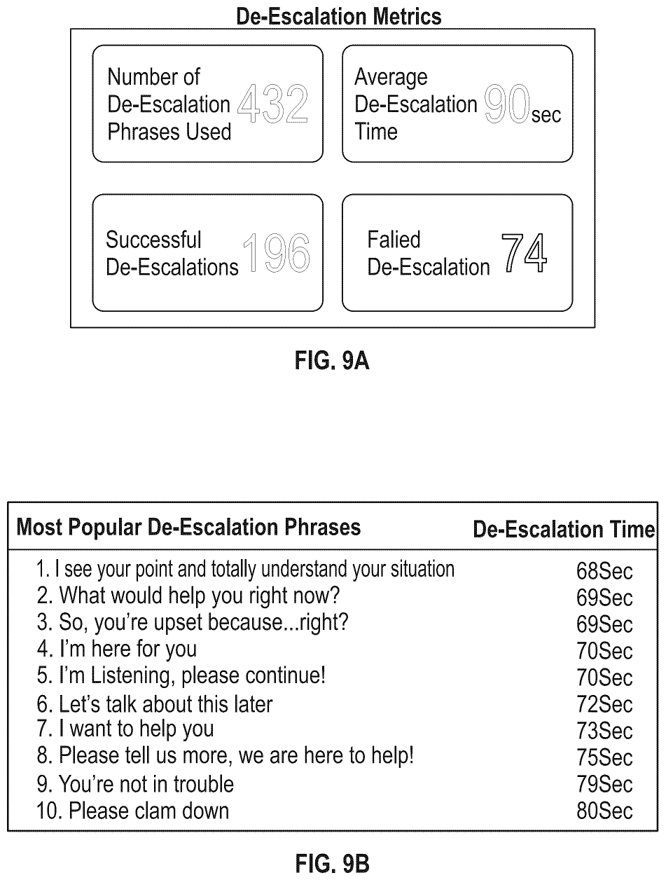

The timeline of events in FIG. 7 can also be summarized as shown in FIG. 10 across various officers. By summarizing the number of negative sentiments, undesirable behaviors and emotions (such as aggression), and other features, the analysis conducted by the methods described herein can act as an early warning system for officers that may either be (1) conveying negative sentiment often and may be unnecessarily escalating situations, or (2) receiving negative sentiment from their interactions and may be approaching burn-out.

Analyzing Unprofessional/Respectful Language with Intent and Entity Detection

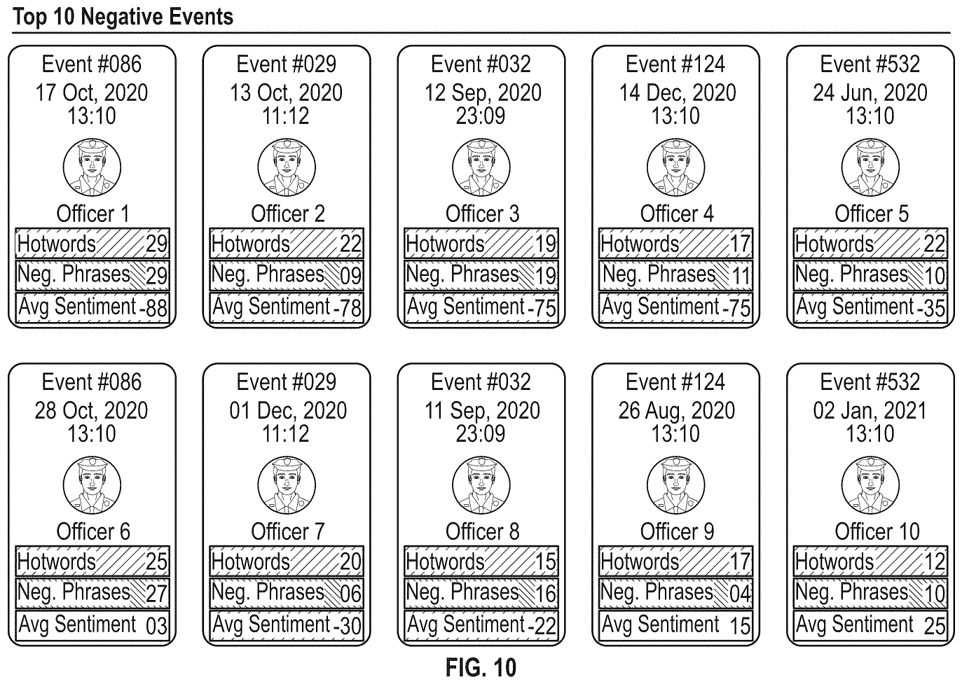

In at least one exemplary embodiment, an intent classifier identifies the event occurring (accident, arrest, etc.) and a sentiment model simply labels the language as positive or negative. As shown in FIG. 11, the system and methods detailed herewithin train an intent and entity model that identifies many linguistic features.

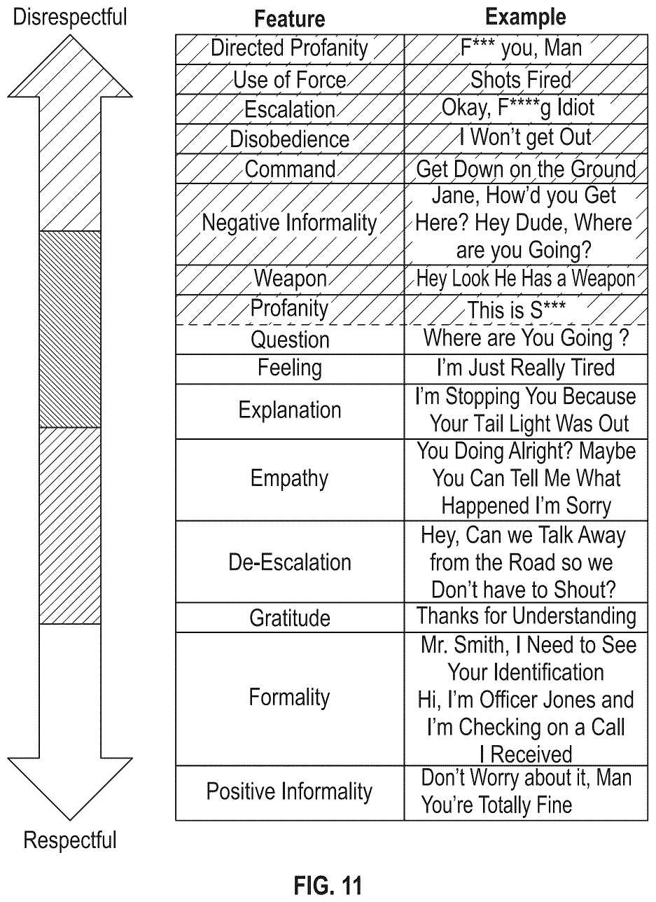

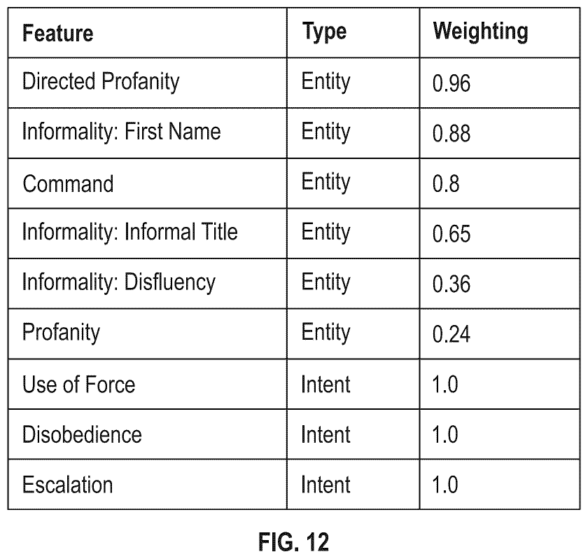

The system and methods detailed herewithin can utilize the features from FIG. 11 and assign them department-tunable weights of importance. Transcripts can be scored based on each of these weights, and the highest relevance videos can then be surfaced by ranking based off of a single score. In at least one instance, the score can be used to rank videos, officers, precincts, and departments, which, for example, can surface outliers and trends. Additionally, in at least one instance, the features of the score not only score the interaction, but side effects on participants. An analogous officer wellness model can include the same features to score which officers may be susceptible to wellness issues based on the same score. All analysis detailed herein, including analysis of score, can be done in real-time or even on the body camera device itself. An example set of weights of positive coefficients (more unprofessional behavior) are shown in FIG. 12. Additionally, an example set of weights of negative coefficients (more respect) are shown in FIG. 13.

### Methods of Officer Identification

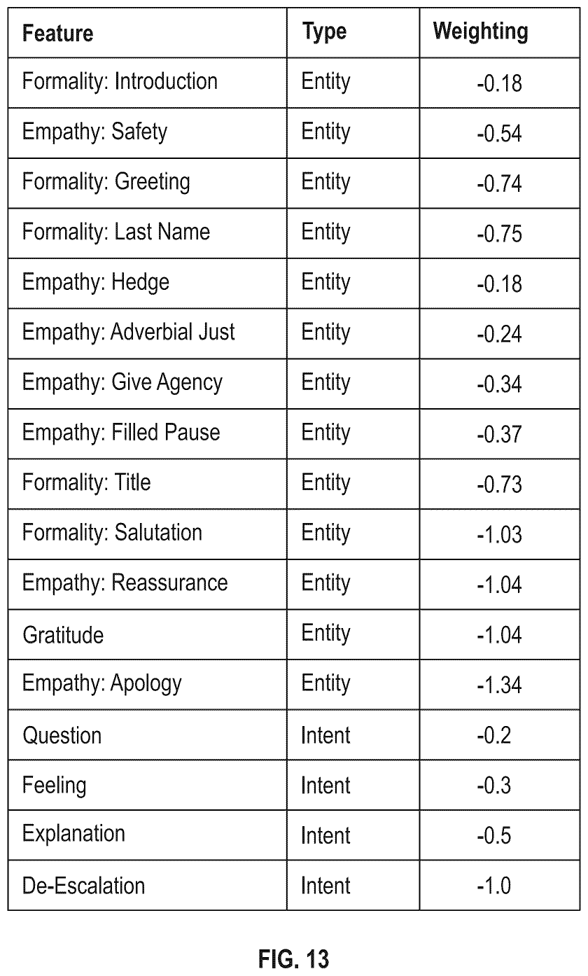

In at least one exemplary embodiment, correctly identifying individual speakers from transcripts enables scoring professionalism in police interactions. Software in the system can correctly separate a transcript into individual speakers and can correctly identify which speaker is the officer wearing the camera from transcripts, including from BWC videos. For example, FIG. 14 shows an exemplary transcription of an interaction between an officer and a driver with a flat tire. When properly identified, the transcription can categorize and separate the officer speech from non-officer speech as shown in the exemplary transcript of FIG. 14.

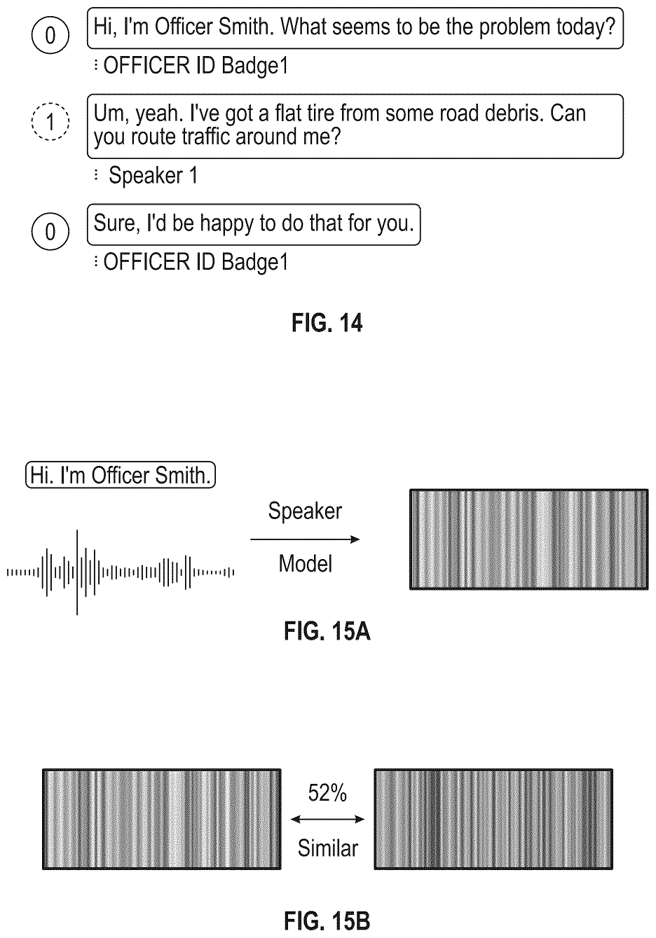

In at least one exemplary embodiment, automatic speaker diarization is performed by a process that involves:
1. Transcribing audio from BWC recordings into a series of words and using the start and stop times of those words to break the audio into segments.
2. Using a machine learning (ML) model built for speaker identification and diarization to convert word-based audio segments into compact representations of the audio signal. These representations are called speaker embeddings. An exemplary speaker embedding is shown in FIG. 15A where a word-based audio segment is shown converted to an embedding.
3. The speaker embeddings are then clustered into a clustering algorithm that groups similar speakers together and assigns labels to each speaker (“Speaker 1”, “Speaker 2”, etc.). Then, the algorithm joins segments with shared speaker labels. An exemplary grouping of similar speaker embeddings grouped together is shown in FIG. 15B.

### Using Voice Printing to Identify Officers

Similar to how people learn to recognize voices very early in their life, machines in the system can also identify speakers. Speaker identification is the process for assigning a segment of audio to a speaker by comparing the segment to some reference voice print.

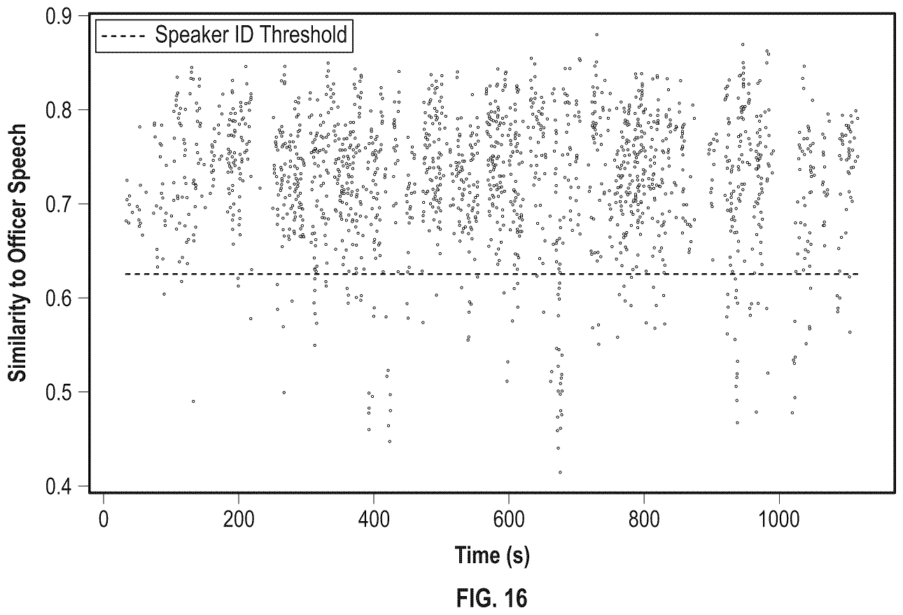

In at least one exemplary embodiment, human-reviewed segments can be used to identify the officer in his or her own BWC videos. After a voice print is identified for a target officer, that voice print for that officer's videos can be used moving forward. The speaker embeddings can be calculated, and any audio segments which closely resemble the officer's voice print are assigned to that officer. All other audio segments can then be fed into the normal speaker diarization process. FIG. 16 shows application of a target officer in exemplary BWC videos.

### Finding a Voice Print Automatically

Providing police departments the power to voice print officers themselves can provide high value. However, in an exemplary embodiment of a police department with thousands of officers, to ease the burden of manual review, identification of an officer's voice fingerprint can be accomplished automatically using metadata and the language the officer used.

For example, first, for each identified speaker, a text-based ML model can be used to evaluate if the transcript of an officer's speech looks like something an officer would say. The speaker whose language looks most like an officer is assigned as the officer for that video. If two or more speakers speak like officers, the higher voice quality is assigned to be the officer to capture the officer who was wearing the camera. If there is uncertainty about which speaker is the officer in a given video, an officer is not assigned.

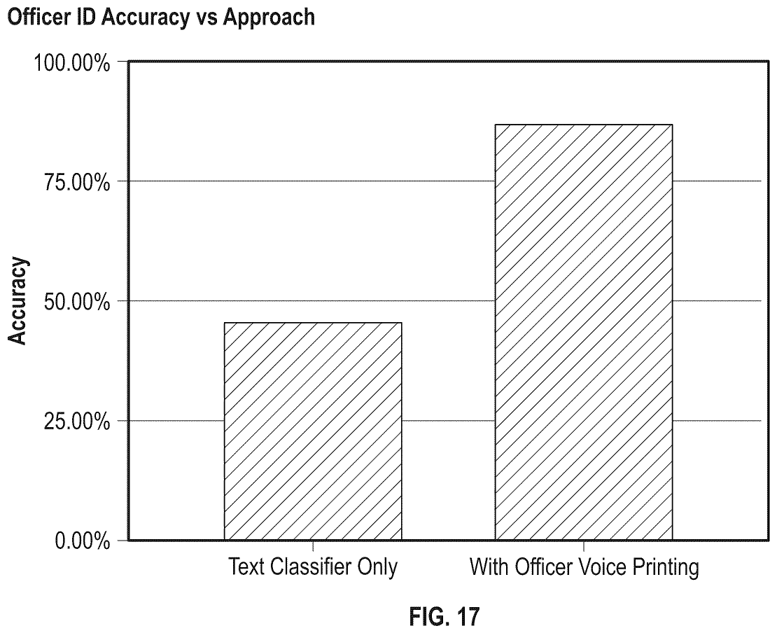

Next, after dozens of videos have been processed for a given officer, a voice print for that officer can be automatically assigned. Speaker embeddings are calculated for all officer segments in the processed videos, where the officer was identified based on text. Then, those speaker embeddings are averaged to find the audio segment most similar to the average speaker embedding, with that particular audio segment becoming the officer's voice print for future videos. FIG. 17 shows exemplary officer ID accuracy comparing text classifiers only and officer voice printing.

### Using Available Microphones

A body-worn camera containing a multi-microphone array can be physically positioned so as to allow robust identification of the directional source of incoming audio signals. The incorporation of this microphone array allows for improvements in the degree of accuracy with which officer speech can be distinguished from non-officer speech. Methods including, but not limited to, time differences of arrival analysis may be used to localize the position of the incoming audio signal relative to the position of the microphone array. In place of, or in addition to, the text classifier used to identify the officer speaking, the localized microphone position can be used as well in determination of the fingerprint.

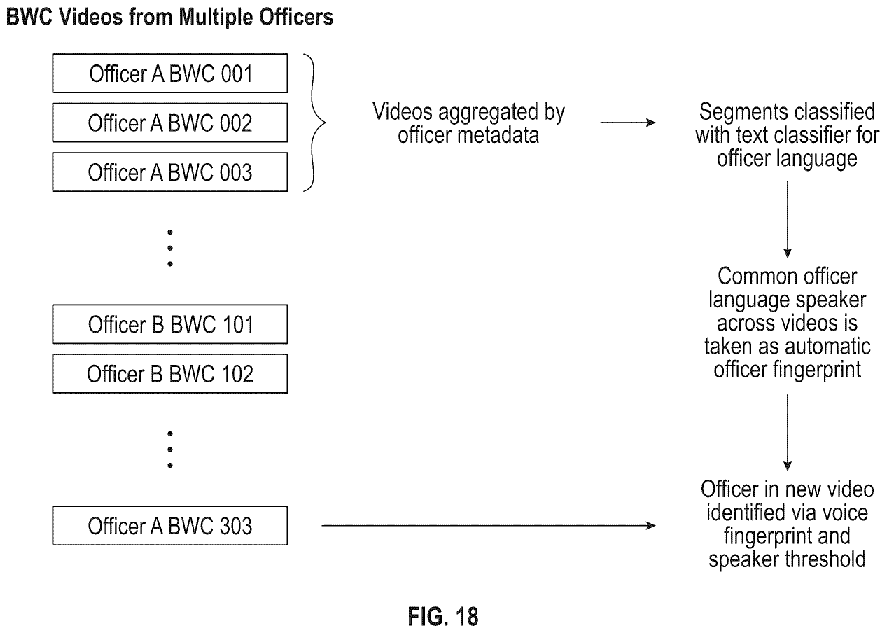

FIG. 18 shows a workflow diagram of BWC videos from multiple officers and application to identify an officer voice fingerprint. As shown in FIG. 18, multiple videos are aggregated by officer metadata. Segments are then classified with text classifiers for officer language. Common officer language speaker across videos is taken as automatic officer fingerprint. The officer in a new video is then identified via voice fingerprint and speaker threshold.

In at least one aspect, the present disclosure includes an audio analysis method to identify behavior, emotion, and sentiment within a body worn camera video. The audio detailed herein can be analyzed in real-time or in historical fashion. The methods detailed herewithin can perform voice activity detection on an audio stream to reduce the amount of audio that needs to be analyzed. Methods shown and/or described herein can identify emotion, behavior, and sentiment using machine-learned classifiers within the transcribed audio. Further, methods shown and/or described herein can measure disfluencies and other voice patterns that are used to further the analysis. Methods shown and/or described herein can include determining which videos should be retained long-term based on an abundance of features of interest. Further still, systems and methods detailed herein can use natural language processing, including via a machine learned model, to analyze body cam audio for behavior and/or emotional sentiment. Even further, linguistic features can be identified in the present systems and methods. In other aspects, systems and methods detailed herein can weight positive and negative coefficients.

In examples involving police officers, natural language processing can be used to score officer performance, respectfulness, wellness, etc. Further, officers can be anonymously detected and identified. Additionally, methods and systems detailed herein can selectively process officer or civilian audio.

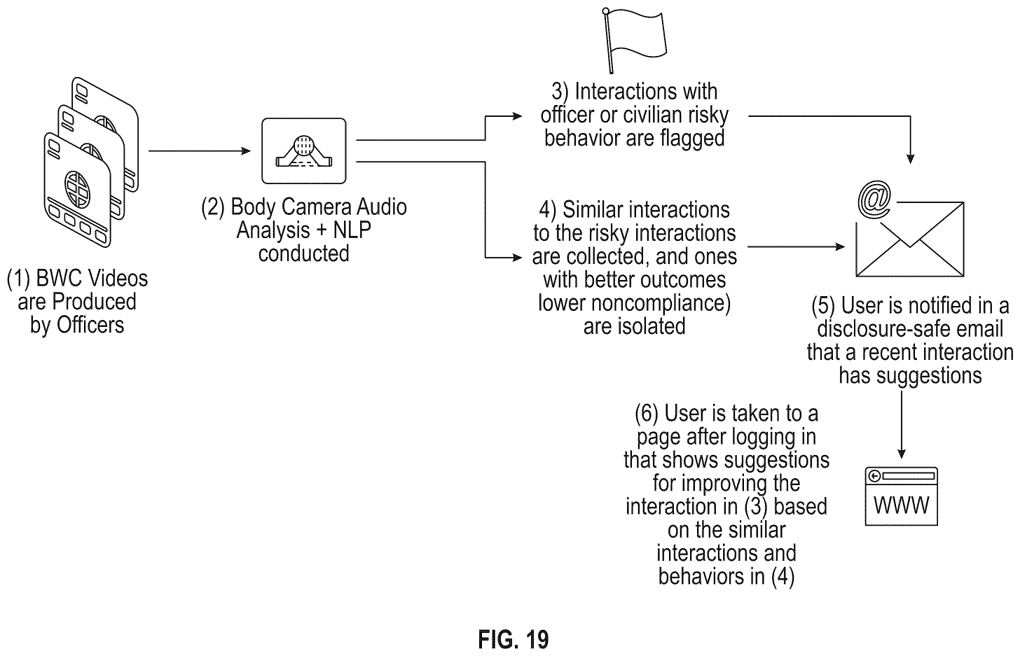

In another aspect, an exemplary embodiment of identification of events and language during interactions can involve the use of a body camera analytics platform that transcribes audio to text, identifies an officer speaking, identifies events occurring or that occurred in an officer civilian interaction via NLP, identifies positive, professional language in the interaction via NLP (such as explanations or politeness), and/or identifies negative language in the interaction (such as profanity, insults, threats, etc.). FIGS. 19-21 show exemplary flow charts of methods of an exemplary embodiment of identifications of events and language during interactions.

In one exemplary method, a user is alerted of a negative interaction and given training suggestions on how to improve the interaction. In one aspect in this exemplary method, the suggestions first compare the response of the officer to his peers. Then, the suggestions compare the response of the civilian to the officers peers' interactions. Finally, the suggestions assert that the officer could achieve less civilian negative response by using less negative language themselves with the comparative data to show. For example, the analysis could conclude that reducing their use of negative language could reduce civilian negative language by X % based on peer interactions.

In an alternative aspect, the exemplary method can include a comparison of civilian noncompliance. Here, the officer could reduce noncompliance by X % after reducing negative language based on peer interactions.

In another alternative aspect, the exemplary method can surface interaction where the officer failed to use explanation and received high civilian noncompliance. Here, the suggestions compare peer interactions with higher explanation and lower noncompliance to offer the user a similar suggestion for improvement.

As shown in FIG. 19, in step (1), BWC videos are produced by officers. In step (2), body camera audio analysis and NLP are conducted. In step (3), interactions with officer or civilian behavior are flagged. In step (4), similar interactions to the interactions are collected, and ones with better outcomes (lower noncompliance) are isolated or otherwise identified. In step (5), a user is notified, e.g., in a disclosure-safe email or other notification method that a recent interaction has suggestions. In step (6), a user is taken to a page, typically after logging in, that shows suggestions for improving the interaction in step (3) based on the similar interactions and behaviors in step (4).

In a second exemplary method, an exemplary method involves a generative artificial intelligence (AI) language model that is trained from officer explanations found via body camera analysis and the context around them. Here, when reviewing a single video, the ability to surface a possible explanation that the officer could have provided can be generated by the model in the second exemplary method given the context in the video in question. In this way, the officer watching the video can receive coaching from an AI model trained off behavior of their most professional peers.

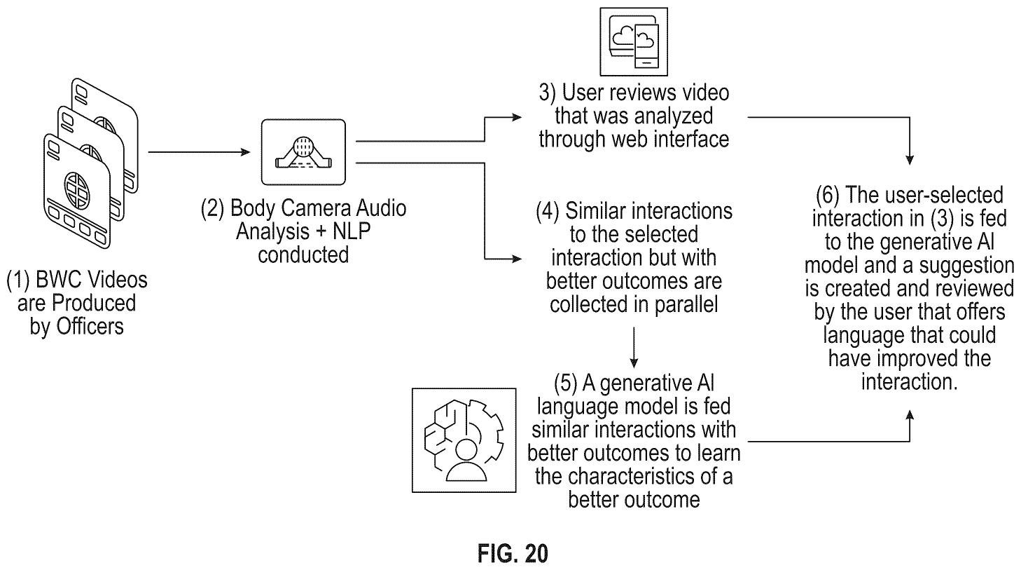

As shown in FIG. 20, in step (1), BWC videos are produced by officers. In step (2), body camera audio analysis and NLP are conducted. In step (3), a user reviews video that was analyzed, e.g., through a web interface. In step (4), similar interactions to the selected interaction but with better outcomes are collected in parallel. In step (5), a generative AI language model is fed similar interactions with better outcomes to learn the characteristics of a better outcome. In step (6), the user-selected interaction in step (3) is fed to the generative AI model and a suggestion is created and reviewed by the user that offer language that could have improved the interaction.

In a third exemplary method, a department is provided an ability to share videos with other departments, including, specifically, for example, which are good examples of training. Videos would be automatically redacted with an AI model that blurs faces/personally identifiable information (PII), removes faces/PII from the transcript, and can use generative AI models to recreate or otherwise mask the participant voices as to not expose the original voices.

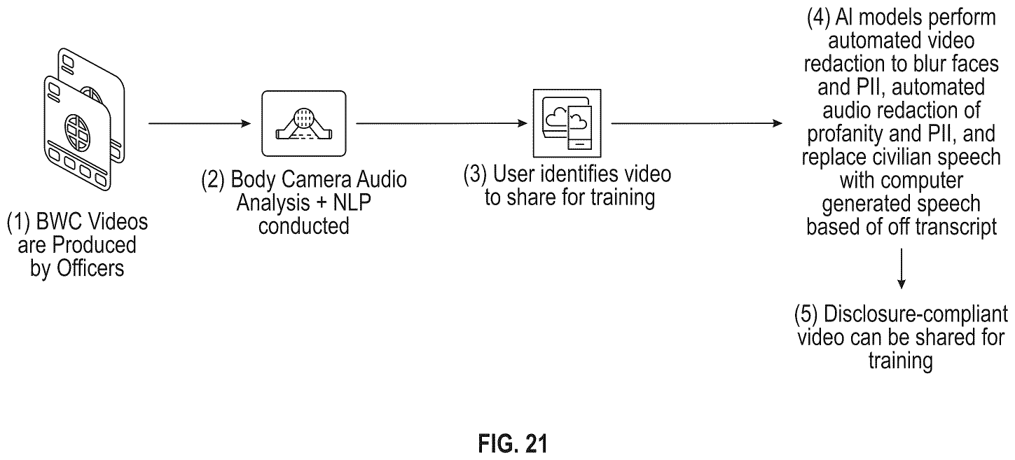

As shown in FIG. 21, in step (1), BWC videos are produced by officers. In step (2), body camera audio analysis and NLP are conducted. In step (3), a user identifies video to share for training. In step (4), AI models perform automated video redaction to blur faces and PII, automated audio redaction of profanity and PII, and replace civilian speech with computer generated speech based off transcript. In step (5), disclosure-compliant video can be shared for training.

In one aspect, a method of rapid verification of officer behavior involves presenting a video segment from a body worn camera for evaluation, labeling the video segment with an accuracy response; wherein the accuracy response confirms whether the video segment was identified correctly as involving critical events and whether the event was unjustified. In one example, the accuracy response can be “yes” to indicate that the video segment was identified correctly as involving the critical event and that the event was unjustified. In one example, the accuracy response can be “no” to indicate that the video segment was not correctly identified as involving critical event or that the event was justified. In one example, the accuracy response can be “not officer”/“not applicable” to indicate that the officer was not correctly identified and that there is no relevance to the officer. In one example, the accuracy response can be “skip” to retain the video segment in a queue. Further, a mobile interface can be provided to allow directional swiping to review the video segment.

In another aspect, a method of identifying speakers in an audio segment involves analyzing a transcript to separate individual speakers, identifying a speaker of the individual speakers as a police officer wearing a body worn camera, weighting the audio segment to identify key phrases associated with unprofessional or respectful interactions involving the police officer, and, tagging events to analyze critical events. Further, a transcription of audio from the police officer, a civilian, or both the officer and the civilian can be prepared. Further, the audio segment can be transcribed into text and each word in the text can be assigned a start time and a stop time. Further, the audio segment can be parsed based on natural pauses in conversation. Further, the audio segment can be transcribed before the audio segment is analyzed for speaker changes. Further, after transcription and diarization, the speaker-separated text transcription can be analyzed through an intent classification model. Further, the intent classification model utilizes a deep-learned transformer architecture and is trained from tagged examples of intent types specific for police interactions.

In another aspect, a method of identifying events and language during an interaction involves transcribing audio to text through a body camera analytics platform, identifying an officer speaking identifying an event occurring or and interaction between the officer and a civilian using natural language processing (NLP), identifying positive language in the interaction using NLP, and, identifying negative language in the interaction using NLP. Further, the officer can be alerted of a negative interaction and provided training suggestions to improve the negative interaction. Further, the suggestions compare a response of the officer to peers of the officer. Further, the suggestions compare the response of the civilian to interactions of the peers of the officer. Further, the suggestions assert that the officer could achieve less civilian negative response by using less negative language. Further, the method can comprise comparing civilian noncompliance. Further, the method can surface interactions where the officer failed to use explanation and received high civilian noncompliance.

The present disclosure can be understood more readily by reference to the instant detailed description, examples, and claims. It is to be understood that this disclosure is not limited to the specific systems, devices, and/or methods disclosed unless otherwise specified, as such can, of course, vary. It is also to be understood that the terminology used herein is for the purpose of describing particular aspects only and is not intended to be limiting.

The instant description is provided as an enabling teaching of the disclosure in its best, currently known aspect. Those skilled in the relevant art will recognize that many changes can be made to the aspects described, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the instant description is provided as illustrative of the principles of the present disclosure and not in limitation thereof.

As used herein, the singular forms “a,” “an” and “the” include plural referents unless the context clearly dictates otherwise. Thus, for example, reference to a “body” includes aspects having two or more bodies unless the context clearly indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

Although several aspects of the disclosure have been disclosed in the foregoing specification, it is understood by those skilled in the art that many modifications and other aspects of the disclosure will come to mind to which the disclosure pertains, having the benefit of the teaching presented in the foregoing description and associated drawings. It is thus understood that the disclosure is not limited to the specific aspects disclosed hereinabove, and that many modifications and other aspects are intended to be included within the scope of the appended claims. Moreover, although specific terms are employed herein, as well as in the claims that follow, they are used only in a generic and descriptive sense, and not for the purposes of limiting the described disclosure.

What is claimed is:

1. A method of identifying speakers in an audio segment comprising:
analyzing a transcript to separate individual speakers;
identifying a speaker of the individual speakers as a police officer wearing a body worn camera;
weighting the audio segment to identify key phrases associated with unprofessional or respectful interactions involving the police officer; and,
tagging events to analyze responses.

2. The method of claim 1 wherein a transcription of audio from the police officer, a civilian, or both the officer and the civilian is prepared.

3. The method of claim 1 wherein the audio segment is transcribed into text and each word in the text is assigned a start time and a stop time.

4. The method of claim 3 wherein the audio segment is parsed based on natural pauses in conversation and the audio segment is transcribed before the audio segment is analyzed for speaker changes.

5. The method of claim 1 further comprising a verification interface that utilizes the method and improves accuracy of predictions by the verification interface by analyzing “not officer” clicks.

6. The method of claim 5 wherein after transcription and diarization, the speaker-separated text transcription is analyzed through an intent classification model.

7. The method of claim 6 wherein the intent classification model utilizes a deep-learned transformer architecture and is trained from tagged examples of intent types specific for police interactions.

8. A method of identifying events and language during an interaction comprising:
transcribing audio to text through a body camera analytics platform;
identifying an officer speaking identifying an event occurring or and interaction between the officer and a civilian using natural language processing (NLP);
identifying positive language in the interaction using NLP; and,
identifying negative language in the interaction using NLP.

9. The method of claim 8 wherein the officer is alerted of a negative interaction and provided training suggestions to improve the negative interaction.

10. The method of claim 9 wherein these suggestions compare a response of the officer to peers of the officer.

11. The method of claim 10 wherein the suggestions compare a civilian response of the civilian to interactions of the peers of the officer.

12. The method of claim 11 wherein the suggestions assert that the officer could achieve less civilian negative response by using less negative language.

13. The method of claim 12 wherein the method surfaces interactions where the officer failed to use explanation and received high civilian noncompliance.

14. The method of claim 8 further comprising a verification interface that utilizes the method and improves accuracy of predictions by the verification interface by analyzing “yes” and “no” clicks.

15. A method of rapid verification of officer behavior comprising:
presenting a video segment from a body worn camera for evaluation;
labeling the video segment with an accuracy response;
wherein the accuracy response confirms whether the video segment was identified correctly as involving a critical event and whether the event was unjustified.

16. The method of claim 15 wherein the accuracy response is “yes” to indicate that the video segment was identified correctly as involving the event and that the event was unjustified.

17. The method of claim 15 wherein the accuracy response is “no” to indicate that the video segment was not correctly identified as involving the event or that the event was justified.

18. The method of claim 15 wherein the accuracy response is “not officer” or “not applicable” to indicate that the officer was not correctly identified and that there is no critical event present.

19. The method of claim 15 wherein the accuracy response is “skip” to retain the video segment in a queue.

20. The method of claim 15 wherein a mobile interface is provided to allow directional swiping to review the video segment.
